(19) United States
(12) Patent Application Publication
(10) Pub. No.: US 2011/0022229 A1
(43) Pub. Date: Jan. 27, 2011

(54) MASTER INTERFACE AND DRIVING METHOD OF SURGICAL ROBOT

(76) Inventors: Bae Sang Jang, Gyeonggi-do (KR); Seung Wook Choi, Gyeonggi-do (KR); Dong Myung Min, Gyeonggi-do (KR); Jong Seok Won, Gyeonggi-do (KR); Kwang Ha, Gyeonggi-do (KR)

Correspondence Address: BIRCH STEWART KOLASCH & BIRCH, PO BOX 747, FALLS CHURCH, VA, 22040-0747, US

(21) Appl. No.: 12/922,608

(22) PCT Filed: Mar. 18, 2009
(86) PCT No.: PCT/KR09/01372

§ 371 Date: Sep. 14, 2010

(30) Foreign Application Priority Data
Jun. 9, 2008 (KR) 10-2008-0053488
Jun. 13, 2008 (KR) 10-2008-0055536
Jul. 25, 2008 (KR) 10-2008-0072714

(51) Int. Cl. B25J 13/02; B25J 9/04

(52) U.S. Cl. 700/248; 901/41; 901/8

(57) ABSTRACT

A master interface and a driving method for a surgical robot are disclosed. The master interface is mounted on a master robot, to manipulate a slave robot connected with the master robot, and includes: a main handle coupled to the master robot; a sub-handle coupled to the main handle; a first processor configured to generate a first signal in correspondence with user manipulation on the main handle; and a second processor configured to generate a second signal in correspondence with user manipulation on the sub-handle, where the first signal and the second signal are transmitted to the slave robot independently. As the interface for the surgical master robot includes not only the handle (main handle) for manipulating the robot arm, but also an additional controller (sub-handle) for a laparoscope, etc., the operator is able to simultaneously manipulate the laparoscope, etc., while manipulating the handle, without having to stop manipulating the handle or perform an additional action separately. The sub-handle may be detachably coupled to the main handle, so that the laparoscope, etc., may be manipulated separately by an assistant when necessary.

### CROSS-REFERENCE TO RELATED APPLICATIONS

This application is the National Phase of PCT/KR2009/001372 filed on Mar. 18, 2009, which claims priority under 35 U.S.C. 119(a) to Patent Application No. 10-2008-0053488 filed in the Republic of Korea on Jun. 9, 2008, Patent Application No. 10-2008-0055536 filed in the Republic of Korea on Jun. 13, 2008, and Patent Application No. 10-2008-0072714 filed in the Republic of Korea on Jul. 25, 2008, all of which are hereby expressly incorporated by reference into the present application.

### BACKGROUND

The present invention relates to a master interface and a driving method of a surgical robot.

In the field of medicine, surgery refers to a procedure in which a medical device is used to make a cut or an incision in or otherwise manipulate a patient's skin, mucosa, or other tissue, to treat a pathological condition. A surgical procedure such as a laparotomy, etc., in which the skin is cut open and an internal organ, etc., is treated, reconstructed, or excised, may entail problems of blood loss, side effects, pain, and scars, and as such, the use of robots is currently regarded as a popular alternative.

A set of surgical robots may include a master robot, which is manipulated by the doctor to generate and transmit the necessary signals, and a slave robot, which receives the signals from the master robot to actually apply the manipulation to the patient. The master robot and the slave robot can be arranged in the operating room as an integrated unit or as separate devices.

An interface may be installed on the master robot by which a surgeon may input the manipulation. The interface may include monitors for displaying various visual information related to surgery, and a handle for operating the robot arm, etc., mounted on the slave robot. The monitors may not only display images of the surgical site photographed by a laparoscope, but may also display information related to the pulse and heart rate of the patient, the temperature and humidity of the operating room, and the operational status of various apparatus. Multiple monitors may be utilized as necessary, to enable the surgeon to properly proceed with the surgery while obtaining the required information in real time.

One or more robot arms may be installed on the slave robot, with a surgical instrument mounted on the end of each robot arm. On the master robot connected to the slave robot, a handle may be installed for inputting the surgeon's manipulation, and as the user operates the handle, the instruments mounted on the slave robot may be operated accordingly to proceed with robot surgery.

In the case of robot surgery, the surgeon does not personally manipulate the instruments required for surgery, and instead conducts surgery using the various instruments mounted on the slave robot, by manipulating the handle mounted on the master robot. The handle may be formed as a multi-joint link assembly, etc., to allow the surgeon to implement actions that are similar to those used when the surgeon personally conducts surgery. As the surgeon manipulates the handle, corresponding signals may be generated and transmitted to the slave robot. The slave robot may then receive the signals transmitted thus from the master robot and move the instruments according to the manipulation of the surgeon.

However, the handle mounted on a conventional master robot may be used only for manipulating the arm of the slave robot, and when additional equipment, such as an auxiliary instrument, a laparoscope, etc., other than the surgical instruments are added to the slave robot, extra personnel dedicated to manipulating such additional equipment may be required.

According to the related art, a foot pedal, etc., may be installed on the master robot, in an effort order to utilize the same handle for manipulating the surgical instrument also for manipulating the auxiliary instrument or laparoscope, etc. In this arrangement, the interface for the master robot may be established such that manipulating the handle without pressing down on the foot pedal moves the surgical instrument, and manipulating the handle while pressing down on the foot pedal moves the laparoscope, etc.

Even in this case, however, the surgeon may not be able to manipulate the various robot surgery equipment simultaneously. When manipulating one of the surgical equipment, the rest may have to remain still. In such cases where the surgeon is able to manipulate just one of the surgical equipment, there is a risk that the inability to manipulate the necessary surgical equipment simultaneously may result in a medical accident, for example in situations that require urgent surgery as well as observing a particular area with a laparoscope.

Also, the handle 150 of a conventional master robot 1 may be such that manipulating the handle 150 causes the multi-joint link assembly 3 to move and rotate, as illustrated in FIG. 5. Thus, a space may be required around the handle 150 for housing the folded multi-link structure 3, and this may impose a limitation in designing the master robot 1.

In addition, when using a handle 150 connected to a conventional multi-link structure 3, it may not be possible to have each link member aligned in a straight line, i.e. the link members may not be extended to 180 degree angles. Instead, stoppers may be formed on the joints 5, as in illustration (a) of FIG. 5, so that the link members may be unfolded only up to a particular angle. If the link is designed to extend up to 180 degrees without a stopper, the force exerted on the handle 150 may be applied along the axial direction of the link members, when the handle 150 is to be moved for retracting the multi-link structure 3 as in illustration (b) of FIG. 5. As a result, the link members may not be bent at the joints 5, or the bending may require an excessive amount of force, making it impossible to provide smooth and comfortable manipulation.

In particular, if the master manipulation handle is for a surgical robot in which the hand movements of the operator are transferred directly to the robot arm, there is a risk that such discomfort in manipulation may lead to a possibly fatal medical accident.

Moreover, with the conventional handle structure illustrated in FIG. 5, the force required to move or rotate the link structure may be different according to the angle formed by the link members. This can result in a number of “singular points,” at which the handle cannot be moved or the handle requires a greater force than is normally necessary for movement, when the operator wants to move the handle to a particular position in space.

Also, in conventional robot surgery, having the instrument perform a particular action may require performing an equivalent action in manipulating the handle. For example, when performing suturing, repetitive rotations on the handle may be required in order to have the instrument perform the same repetitive rotational movements, and this may lead to less stable movements, due to an excessive strain on the manipulator's wrist, as well as a risk of malfunctioning.

The information in the background art described above was obtained by the inventors for the purpose of developing the present invention or was obtained during the process of developing the present invention. As such, it is to be appreciated that this information did not necessarily belong to the public domain before the patent filing date of the present invention.

### SUMMARY

An aspect of the present invention aims to provide a master interface for a surgical robot and a method of driving the surgical robot, by which the handle of a surgical master robot can be manipulated to manipulate the arm of a slave robot and to simultaneously manipulate other surgical equipment such as a laparoscope, etc.

Also, another aspect of the present invention is to provide a manipulation device for a master robot that enables the operator to smoothly move the handle to a desired position by exerting an even amount of force and does not require unnecessary space around the handle.

Also, another aspect of the present invention is to provide a master interface for a surgical robot that enables the operator to implement repetitive rotating actions for the instrument, without having to repeatedly rotate the operator's wrist, so that the surgery may be performed with greater stability.

Other technical problems addressed by the present invention will be readily understood from the descriptions that follow.

One aspect of the present invention provides a master interface for a surgical robot. The master interface is mounted on a master robot, to manipulate a slave robot connected with the master robot, and includes: a main handle coupled to the master robot; a sub-handle coupled to the main handle; a first processor configured to generate a first signal in correspondence with user manipulation on the main handle; and a second processor configured to generate a second signal in correspondence with user manipulation on the sub-handle, where the first signal and the second signal are transmitted to the slave robot independently.

A surgical robot arm and a laparoscope can be mounted on the slave robot, in which case the first signal can be used for manipulating the robot arm, and the second signal can be used for manipulating the laparoscope. The sub-handle can be coupled to the main handle in a manner that enables the sub-handle to be separated while maintaining connection with the second processor, and can be connected with the second processor by wireless communication while separated from the main handle.

The master robot can include a monitor configured to display information required for manipulating the slave robot, in which case the second signal can be used for manipulating a cursor on the monitor. A clutch button may additionally be coupled to the master robot, and the second signal can be used for manipulating the cursor on the monitor in correspondence with whether or not the clutch button is activated.

The first processor can be configured to compare data obtained from user manipulation on the main handle with preset reference data and generate the first signal according to whether or not the obtained data match the preset reference data. Similarly, the second processor can be configured to compare data obtained from user manipulation on the sub-handle with preset reference data and generate the second signal according to whether or not the obtained data match the preset reference data.

Another aspect of the present invention provides a method for driving a surgical robot which is a method of driving a slave robot connected with a master robot by manipulating a main handle coupled to the master robot and a sub-handle coupled to the main handle. The method includes: generating a first signal in correspondence with user manipulation on the main handle; generating a second signal in correspondence with user manipulation on the sub-handle; and transmitting the first signal and the second signal to the slave robot independently.

The sub-handle can be detachably coupled to the main handle, and the operation of generating the second signal can include an operation of obtaining data on user manipulation on the sub-handle by wireless communication while the sub-handle is separated from the main handle.

An additional clutch button can be coupled to the master robot, and the method can further include, before the operation of generating the second signal: an operation of determining whether or not the clutch button is activated. Here, if the clutch button is activated, the operation of generating the second signal can include an operation of generating a particular signal used by the surgical robot for performing a particular function.

The operation of generating the first signal can include: (a) obtaining data from user manipulation on the main handle; (b) comparing the obtained data with preset reference data; and (c) generating the first signal according to whether or not the obtained data match the preset reference data. Here, operation (c) can include, if the obtained data match the preset reference data: an operation of generating a particular signal used by the slave robot for performing a particular function.

The operation of generating the second signal can include: (d) obtaining data from user manipulation on the sub-handle; (e) comparing the obtained data with preset reference data; and (f) generating the second signal according to whether or not the obtained data match the preset reference data. Here, operation (f) can include, if the obtained data match the preset reference data: an operation of generating a particular signal used by the slave robot for performing a particular function.

Still another aspect of the present invention provides a manipulation device for a master robot that is connected to the master robot to manipulate a slave robot connected to the master robot. The manipulation device includes: a joint part coupled to the master robot; a scissor-link part coupled to the joint part; and a handle part coupled to the scissor-link part.

On the slave robot, a surgical robot arm can be coupled, which may be configured to move and rotate in correspondence with a movement and rotation of the manipulation device. The joint part can be coupled to the master robot by way of a first rotational axis, or the scissor-link part can be coupled to the joint part by way of a first rotational axis, or the handle part can be coupled to the scissor-link part by way of a first rotational axis. In such cases, the scissor-link part can be coupled to the joint part by way of a second rotational axis that intersects the first rotational axis.

The scissor-link part can include a composite of a first link member and a second link member connected to each other in a scissor-like manner by way of a first pivot pin, where many composites may be connected sequentially along a lengthwise direction by way of second pivot pins. In this way, the scissor-link part can be made to extend or retract along the lengthwise direction.

A pair of second link members can be connected respectively to both sides of one first link member, and the manipulation device can further include gap-modifying parts that bind the pair of second link members together. The gap-modifying part can be a bolt, screw, rivet, etc., that applies pre-tension to the pair of second link members. The first pivot pins and the second pivot pins can connect the first link members and the second link members by way of interposed flange bearings.

The manipulation device can also include a first driving motor, for rotating the first link member and the second link member about the first pivot pin, and a second driving motor, for rotating the first link member and the second link member about the second pivot pin. The first driving motor and the first pivot pin can be connected by a pulley, and likewise, the second driving motor and the second pivot pin can be connected by a pulley

The first link member can be coupled to the joint part by way of the second rotational axis, where a portion of the first link member may extend beyond the second rotational axis, and a weight corresponding with a mass of the scissor-link part may be coupled to the extended portion of the first link member. In this case, the first driving motor and the second driving motor can be included in the weight.

Yet another aspect of the present invention provides a master interface for a surgical robot. The master interface is installed on a master robot connected with a slave robot, so as to manipulate a surgical instrument mounted on the slave robot, and includes: a handle coupled to the master robot; a manipulation wheel that is coupled to the handle and configured to rotate about a particular rotational axis; and a processor that is mounted on the master robot and configured to generate a signal for driving the instrument in correspondence with a rotation of the manipulation wheel.

The processor can generate a signal for rotating the tip of the instrument in correspondence with a degree of rotation of the manipulation wheel. The instrument can be mounted on the slave robot such that the tip of the instrument is able to rotate within a preset range, while a force-feedback part can be coupled to the manipulation wheel to apply a reaction force to limit the rotation of the manipulation wheel, and the processor can be configured to generate a signal for activating the force-feedback part when the manipulation wheel is rotated such that the instrument would exceed the preset range of rotation. The handle can be shaped to allow a user to grip the handle with one hand, and the manipulation wheel can be coupled in a position that allows a user to manipulate the manipulation wheel with a middle finger when the user grips the handle.

The manipulation wheel can be coupled to the handle in such a way that allows a clicking action, in which case, the processor can be configured to generate a signal for returning the instrument to a preset position in correspondence with a clicking action of the manipulation wheel.

Additional aspects, features, and advantages, other than those described above, will be obvious from the claims and written description below.

According to certain embodiments of the present invention, an interface for a surgical master robot may include not only the handle (main handle) for manipulating the robot arm, but also an additional controller (sub-handle) for a laparoscope, etc., thereby enabling the operator to simultaneously manipulate the laparoscope, etc., while manipulating the handle, without having to stop manipulating the handle or perform an additional action separately. Also, the sub-handle may be detachably coupled to the main handle, so that the laparoscope, etc., may be manipulated separately by an assistant when necessary.

A sub-handle according to an embodiment of the present invention may also be utilized as an input device for manipulating a cursor on a monitor screen installed on the interface of the master robot. In addition, the surgical robot can be made to perform a particular function when the main handle and/or the sub-handle is manipulated in a certain way, using a “motion command” function.

As a scissor type link is applied to the manipulation device mounted on the master robot, there is no need to provide a separate space around the handle for moving and rotating the link structure. Also, when moving the handle to a particular position in space, the operator is able to manipulate the handle with an even amount of force, without having to exert an excessive amount of force, and the occurrence of “singular points,” at which it is difficult or impossible to move the handle, can be greatly reduced or eliminated completely.

A manipulation wheel can be mounted onto the master handle coupled to the master interface of a surgical robot, where the instrument can be made to rotate according to the rotation of the manipulation wheel. This allows the operator to implement a repetitive rotating action on the instrument simply by rotating the manipulation wheel with a finger, instead of arduously rotating the wrist repeatedly. As such, a surgical procedure, such as suturing, etc., may be readily implemented in a stable manner without putting a strain on the operator's wrist.

### BRIEF DESCRIPTION OF THE DRAWINGS

FIG. 1 is a plan view illustrating the overall structure of a surgical robot according to an embodiment of the present invention.

FIG. 2 is a schematic drawing illustrating a master interface for a surgical robot according to an embodiment of the present invention.

FIG. 3 is a flowchart illustrating a driving method for a surgical robot according to an embodiment of the present invention.

FIG. 4 is a flowchart illustrating a driving method for a surgical robot according to another embodiment of the present invention.

FIG. 5 is a schematic drawing illustrating a manipulation device for a master robot according to the related art.

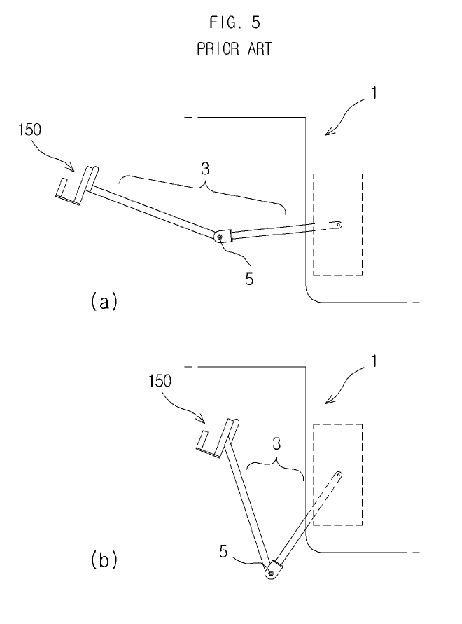

FIG. 6 is a perspective view of a manipulation device for a master robot according to an embodiment of the present invention.

FIG. 7 is a schematic drawing illustrating the operation of a manipulation device for a master robot according to an embodiment of the present invention.

FIG. 8 is a schematic drawing illustrating a master interface for a surgical robot according to an embodiment of the present invention.

FIG. 9 is a perspective view of a handle according to an embodiment of the present invention.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the written description, certain detailed explanations of related art are omitted when it is deemed that they may unnecessarily obscure the essence of the present invention.

While such terms as “first” and “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Certain embodiments of the present invention will be described below in detail with reference to the accompanying drawings. Those components that are the same or are in correspondence are rendered the same reference numeral regardless of the figure number, and redundant descriptions are omitted.

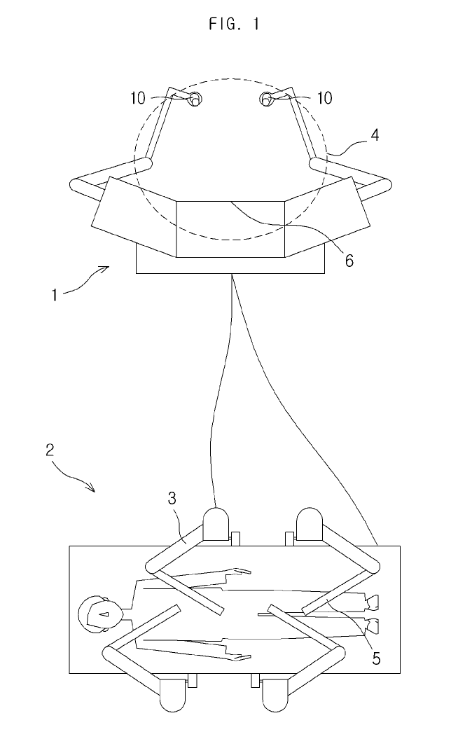

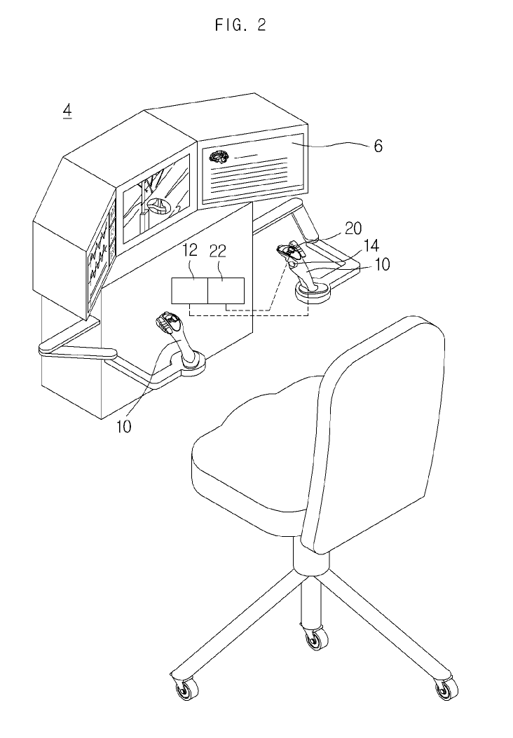

FIG. 1 is a plan view illustrating the overall structure of a surgical robot according to an embodiment of the present invention, and FIG. 2 is a schematic drawing illustrating a master interface for a surgical robot according to an embodiment of the present invention. Illustrated in FIG. 1 and FIG. 2 are a master robot 1, a slave robot 2, robot arms 3, a master interface 4, a laparoscope 5, monitors 6, main handles 10, a first processor 12, a clutch button 14, sub-handles 20, and a second processor 22.

A feature of this embodiment is the master interface 4, which enables an operator using a handle for manipulating a robot arm 3 to simultaneously manipulate another surgical equipment in real time, without stopping the manipulation on the handle or performing an extra action. This is achieved by installing an additional handle for manipulating the other surgical equipment, such as a laparoscope 5, etc., on the handle for manipulating a slave robot arm 3 mounted on the interface of a surgical master robot 1, i.e. the master interface 4. In the descriptions that follow, the handle for manipulating the slave robot arm 3 will be referred to as a “main handle,” while the handle additionally installed on the main handle 10 will be referred to as a “sub-handle 20.”

In this embodiment, the master interface 4 is a concept that encompasses not only the manipulation handles mounted on the surgical master robot, but also the processors for signal processing, consoles, monitors 6, and other operating switches connected to the handles. The master interface 4 serves as an interface which identifies user manipulation on the master robot 1 to operate the slave robot.

A feature of the master interface 4 according to the present embodiment is that one or more main handles 10 are coupled to the master robot 1, and one or more sub-handles 20 are additionally coupled to the main handles 10. That is, instead of manipulating a slave robot arm 3 and a laparoscope 5, etc., with just one handle, a sub-handle 20 is added, to simultaneously manipulate a multiple number of surgical equipment in real time.

The main handle 10 and sub-handle 20 can be implemented in various mechanical compositions according to the manipulation method. FIG. 2 illustrates an example in which the main handles 10 and sub-handles 20 are implemented in the form of joysticks. Other examples may use various other inputting means for operating the robot arms 3 and other surgical equipment as the main handle 10 and/or the sub-handle, including keypads, trackballs, touchscreens, etc.

On the main handle 10, a first processor 12 may be connected that identifies user manipulation on the main handle 10 and generates a corresponding signal, and on the sub-handle 20, a second processor 22 may be connected that identifies user manipulation on the sub-handle 20 and likewise generates a corresponding signal. Referring to the first and second processors 12, 22 is merely for differentiating the courses of signal processing, and it is obvious that the first and second processors 12, 22 do not necessarily have to be physically separate and can be integrated in a single semiconductor chip.

For example, if the main handle 10 and the sub-handle 20 are implemented in the form of joysticks, the first and second processors 12, 22 may identify the direction of manipulation in each joystick, generate signals that cause the slave robot arms 3 to move and rotate according to the direction of manipulation in each joystick, and transmit the signals to the slave robot 2.

Referring to a signal generated by the first processor 12 as a first signal and a signal generated by the second processor 22 as a second signal, a feature of the master interface 4 according to the present embodiment is that the first signal and the second signal are transmitted to the slave robot 2 independently of each other.

Here, to state that the signals are transmitted “independently” means that the signals do not interfere with each other and that any one signal does not affect the other. Transmitting the two signals independently can be achieved in a variety of ways, such as by having the processors add header information to each of the first and second signals, by transmitting each of the signals in the order in which they are generated, or by establishing an order of priority and transmitting the signals according to that order.

Consider an example in which the main handle 10 is set to operate the slave robot arm 3 and the sub-handle 20 is set to operate a laparoscope 5. When the main handle 10 is manipulated to the right and the sub-handle 20 is manipulated to the left, the first signal generated by the manipulation of the main handle 10 and the second signal generated by the manipulation of the sub-handle 20 may be transmitted respectively to the slave robot 2 without interfering with or affecting each other, so that the first signal may be used in operating the robot arm 3 and the second signal may be used in operating the laparoscope 5.

Thus, while manipulating the main handle 10 to operate the robot arm 3, it is possible to simultaneously manipulate the sub-handle 20 to operate another surgical equipment such as a laparoscope 5 in real time, without having to stop manipulating the main handle 10 or performing an extra action, such as pressing another button, etc., that is, without having to stop the operation of the robot arm 3.

While the above description has been presented with regard to an example in which a surgical robot arm 3 and a laparoscope 5 are mounted on the slave robot 2, the master interface 4 according to the present embodiment can be implemented to accommodate various surgical equipment, other than the robot arm 3 and laparoscope 5. That is, by using the master interface 4 according to this embodiment, it is possible to operate a surgical equipment while simultaneously operating another surgical equipment in real time.

According to this embodiment, the sub-handle 20 can be detachably mounted on the main handle 10. While it is possible for an operator to perform surgery by manipulating the main handle 10 and the sub-handle 20 simultaneously and thereby operating a multiple number of surgical equipment, there may some instances in which a particular surgical equipment needs to be manipulated separately by an assistant. In this case, the sub-handle 20 can be detached from the main handle 10, so that the assistant may manipulate only the sub-handle 20.

For example, if, while an operator is operating the robot arm 3 to perform surgery, a high-precision laparoscopic image is needed, the sub-handle 20 can be detached and manipulated by an assistant, to improve the stability and reliability of the surgery.

When the sub-handle 20 is separated from the main handle 10 for manipulation, it may still be necessary to generate and transmit second signals that correspond to the manipulation of the sub-handle 20. As such, the sub-handle 20 may be connected to second processor 22 even when the sub-handle 20 is detached from the main handle 10. For example, if the sub-handle 20 is detachably coupled to the main handle 10, and the sub-handle 20 and the second processor 22 connected by a communication line, then the sub-handle 20 can be made to maintain connection with the second processor 22 by way of the communication line, even when the sub-handle 20 is separated from the main handle 10.

Furthermore, by mounting wireless communication modules on the sub-handle 20 and the second processor 22, respectively, so as to allow wireless communication between the sub-handle 20 and the second processor 22 even when the sub-handle 20 is detached, it is possible to maintain connection between the sub-handle 20 and the second processor 22 without using a communication line.

If the sub-handle 20 is connected to the second processor 22 by wireless communication in this manner, the sub-handle 20 may be separated and manipulated by an assistant, etc., with a greater level of freedom. Any of a variety of communication systems can be used for wireless communication between the sub-handle 20 and the second processor 22, including IR systems, RF systems, Bluetooth, ZigBee, etc.

The sub-handle 20 according to this embodiment can also be used as an input device for operating a cursor on the screen of a monitor 6 mounted on the master robot 1. A multiple number of monitors 6 can be mounted on the master robot 1 to not only display images of the surgical site as photographed by a laparoscope 5, but also display various other information required for surgery, as well as a graphic user interface (GUI) for operating the surgical robot. The screens displayed on the monitors 6 can be used as above for simply outputting information, but in some cases, the monitors 6 can also be used by an operator to input information, such as by moving a cursor, etc.

Instead of providing a separate inputting device, such as a mouse or a digitizer, etc., to enable an operator to enter a particular input, the sub-handle 20 according to the present embodiment may be used as an inputting device, similar to a mouse.

For example, a clutch button 14 can be installed on the master robot 1, and when the clutch button 14 is pressed, the second signals generated by manipulating the sub-handle 20 can be used for moving a cursor on the monitor 6. Thus, during surgery, the operator may press the clutch button 14 to use the sub-handle 20 as an inputting device for a GUI screen, and after entering the required input, the operator may press the clutch button 14 to again use the second signals for operating the surgical device, such as the laparoscope 5, etc.

This configuration for using a handle mounted on the master interface 4 as an input device for a GUI on the screen of the monitor 6 can also be applied to the main handle 10, as well as the sub-handle 20.

In addition, the main handle 10 and/or the sub-handle 20 according to this embodiment can be used as a “motion command” input device. Entering a motion command is to move the handle in a particular sequence, which can be identified as a particular command that activates a preset function.

For example, rotating the main handle 10 once in a clockwise direction can be identified as a command to replace the instrument mounted on the robot arm 3, so that a first signal may be generated that causes a lamp to blink, indicating that the instrument needs to be replaced, instead of actually rotating the robot arm 3 clockwise. In another example, moving the sub-handle 20 along a Z direction can be identified as a command to zoom in or out on the screen of the monitor 6, so that a second signal may be generated that causes the screen of the monitor 6 to zoom in or out, instead of operating the laparoscope 5 along a Z direction.

Implementing this motion command function may require presetting a set of reference data regarding particular movements of the handles and having the processors compare the identified movement of the respective handles with the preset reference data when generating the signals.

In other words, before the first processor 12 generates a first signal according to the manipulation of the main handle 10 and transmits the first signal to the slave robot 2, the first processor 12 may compare the data obtained from the manipulation of the main handle 10 the preset reference data, and check whether or not the two sets of data match. Likewise, before the second processor 22 generates a second signal according to the manipulation of the sub-handle 20 and transmits the second signal to the slave robot 2, the second processor 22 may compare the data obtained from the manipulation of the sub-handle 20 the preset reference data, and check whether or not the two sets of data match.

If this motion command function is applied, when the main handle 10 and/or the sub-handle 20 is moved in a manner that matches the preset reference data, the first processor 12 and/or second processor 22 may generate and transmit a first signal and/or second signal that conveys a particular command corresponding to the preset reference data, instead of a signal representing the movement of the handle.

In order to provide smooth operation, without having the operation of the surgical equipment conflict with certain motion commands, it can be advantageous to set the motion commands for movements that are typically not used in robot surgery procedures. If necessary, a separate switch, etc., can be installed for initiating the motion command function. Then, activating the switch can initiate the motion command function for the main and/or sub-handle 10, 20 and turning off the switch can deactivate the motion command function, so that the surgical equipment may again be operated according to the movement of the handle.

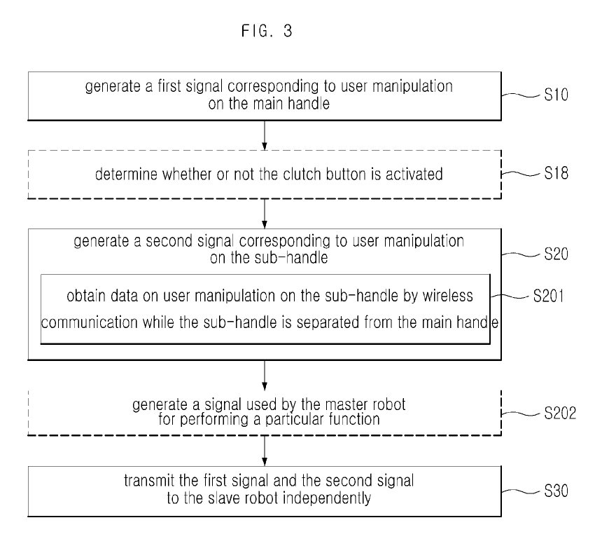

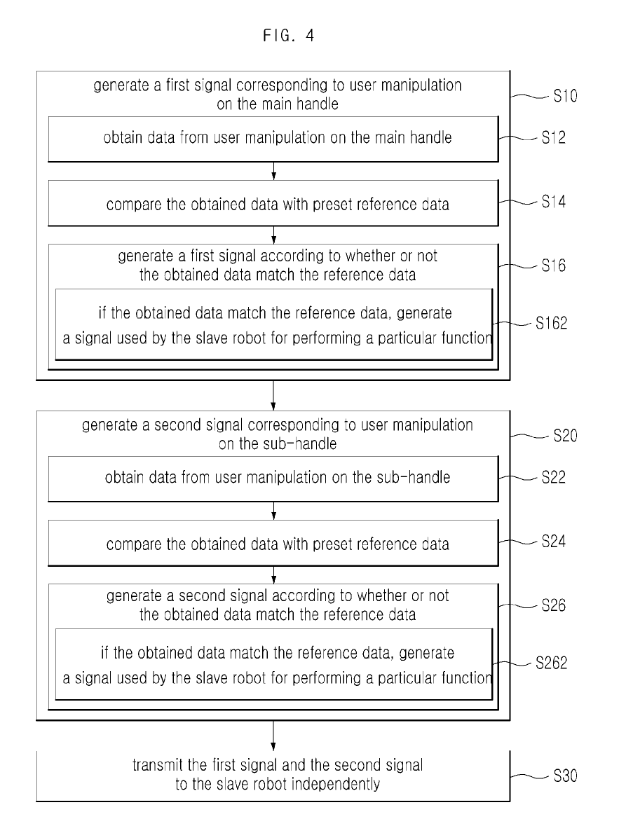

FIG. 3 is a flowchart illustrating a driving method for a surgical robot according to an embodiment of the present invention, and FIG. 4 is a flowchart illustrating a driving method for a surgical robot according to another embodiment of the present invention. A description will now be provided, with reference to FIG. 3 and FIG. 4, on a method of driving a surgical robot on which the master interface described above is mounted.

The master interface 4 according to this embodiment includes a sub-handle 20 coupled additionally to the main handle 10. When the operator manipulates the main handle 10, a first signal may be generated according to the manipulation (S10), and when the operator manipulates the sub-handle, a second signal may be generated according to the manipulation (S20), where the first signal and the second signal may be transmitted to the slave robot 2 independently, without interfering with or affecting each other (S30).

The first signal and second signal transmitted to the slave robot 2 may each be used in operating a robot arm 3 or a surgical equipment, such as a laparoscope 5, etc. Thus, by manipulating the main handle 10 and the sub-handle 20 simultaneously, the robot arm 3 or surgical equipment such as a laparoscope 5, etc., may be operated simultaneously in real time.

As described above, the sub-handle 20 according to this embodiment can be mounted in such a way that the sub-handle 20 may be detached from the main handle 10. In this case, when the sub-handle 20 is manipulated separated from the main handle 10, the data corresponding to the manipulation on the sub-handle 20 can be transferred to the second processor 22 by wireless communication (S201). The second processor 22 may obtain the data according to the manipulation of the sub-handle 20, generate a corresponding second signal, and transmit the second signal to the slave robot 2.

Also, the sub-handle 20 according to the present embodiment can be used as an input device, etc., for operating a cursor on the screen of a monitor 6 mounted on the master robot 1, as described above. For this purpose, a clutch button 14 can be installed on the master robot 1, and when the clutch button 14 is pressed, the second signal generated by manipulating the sub-handle 20 can be used for moving a cursor on the monitor 6.

In this case, the second processor 22 may determine whether or not the clutch button 14 is activated (S18), before generating a second signal according to the manipulation of the sub-handle 20, and if the clutch button 14 is activated, may generate a second signal for moving the cursor on the monitor 6 according to the manipulation of the sub-handle 20.

While the above has illustrated an example in which the sub-handle 20 is used as an inputting device for moving a cursor on a monitor 6 when the clutch button 14 is activated, it is obvious that various other configurations are possible, where activating the clutch button 14 may generate a second signal that allows the sub-handle 20 to be used by the master robot 1 for performing various other functions (S202).

The above configuration, in which a separate clutch button 14 is provided that allows a handle mounted on the master interface 4 to perform a particular function, can be applied not only to the sub-handle 20 but also to the main handle 10. In this case, the first processor 12 may determine whether or not the clutch button 14 is activated, before generating a first signal according to the manipulation of the main handle 10, and if the clutch button 14 is activated, may generate a first signal for moving the cursor on the monitor 6 according to the manipulation of the main handle 10.

Furthermore, as described above, the main handle 10 and/or the sub-handle 20 according to this embodiment can be used as a “motion command” input device. That is, a set of reference data can be preset for certain movements of the handle, and each processor can compare the data on the identified movement of the handle with the preset reference data and then generate the first or second signal accordingly.

When using the main handle 10 as a motion command input device, the operation of generating a first signal according to the manipulation of the main handle 10 (S10) can include recognizing the movement of the main handle 10 manipulated by the user, determining whether or not the movement corresponds to a particular preset movement, and generating the first signal to perform a particular preset function if the movement does correspond to the preset movement.

That is, data may be obtained from user manipulation on the main handle 10 (S12), the obtained data may be compared with a set of preset reference data to check whether or not there is a match (S14), and then the first signal may be generated differently according to whether or not the obtained data match the preset reference data (S16).

If the data obtained from the manipulation on the main handle 10 matches the reference data, a first signal may be generated that causes the surgical robot to perform a particular preset function (S162), and if the data do not match, a first signal may be generated that causes the slave robot 2 to operate in correspondence with the manipulation of the main handle 10.

When using the sub-handle 20 as a motion command input device, the operation of generating a second signal according to the manipulation of the sub-handle 20 (S20) can include recognizing the movement of the sub-handle 20 manipulated by the user, determining whether or not the movement corresponds to a particular preset movement, and generating the second signal to perform a particular preset function if the movement does correspond to the preset movement.

That is, data may be obtained from user manipulation on the sub-handle 20 (S22), the obtained data may be compared with a set of preset reference data to check whether or not there is a match (S24), and then the second signal may be generated differently according to whether or not the obtained data match the preset reference data (S26).

If the data obtained from the manipulation on the sub-handle 20 matches the reference data, a second signal may be generated that causes the surgical robot to perform a particular preset function (S262), and if the data do not match, a second signal may be generated that causes the slave robot 2 to operate in correspondence with the manipulation of the sub-handle 20.

When the motion command function is applied in this manner, moving the main handle 10 and/or sub-handle 20 in a sequence that matches the preset reference data may result in a first signal and/or second signal that transfers a particular command corresponding to the preset reference data, instead of a signal the corresponds to the movement of the handle.

In this case also, the first signal generated according to the manipulation of the main handle 10 and the second signal generated according to the manipulation of the sub-handle 20 may be transmitted to the slave robot independently, without interfering with or otherwise affecting each other. Thus, the motion commands entered by manipulating the main handle 10 and sub-handle 20 may each translate to a particular function independently.

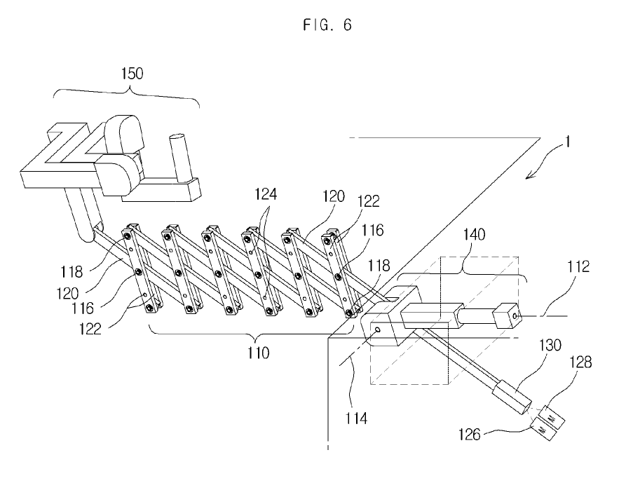

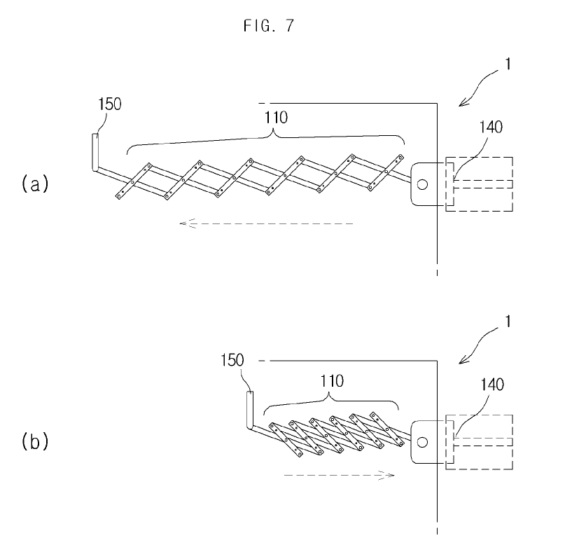

FIG. 6 is a perspective view of a manipulation device for a master robot according to an embodiment of the present invention, and FIG. 7 is a schematic drawing illustrating the operation of a manipulation device for a master robot according to an embodiment of the present invention. Illustrated in FIG. 6 and FIG. 7 are a master robot 1, a scissor-link part 110, a first rotational axis 112, a second rotational axis 114, first pivot pins 116, second pivot pins 118, first link members 120, second link members 122, gap-modifying parts 24, a first driving motor 126, a second driving motor 128, a weight 130, a joint part 140, and a handle part 150.

A feature of this embodiment is that a scissor-type link is applied to the manipulation device coupled to the master robot 1, in a surgical robot composed of a master robot and a slave robot connected to the master robot, so that the handle may be moved smoothly, and the number of singular points may be greatly reduced.

A surgical robot according to this embodiment may include a master robot 1 and a slave robot, where the master robot 1 and the slave robot may be connected by a communication cable, etc., so that when an operator manipulates the master robot 1, a robot arm mounted on the slave robot may move and rotate accordingly. In other words, the slave robot may receive signals transmitted from the master robot 1 to move the robot arm according to the manipulation of the operator.

Instead of moving the robot arm directly, an operator performing robot surgery may move and rotate a manipulation device mounted on the master robot 1, at which the surgical robot arm mounted on the slave robot may move and rotate accordingly. By installing a surgical instrument, etc., on the end portion of the robot arm, the operator may perform robot surgery by remotely manipulating the robot arm, just as one would manipulate an instrument with one's own hand.

This embodiment relates to a manipulation device connected to a master robot 1 such as that described above. The main structure of the manipulation device includes a handle part 150, which is gripped and moved by the operator, coupled by way of a scissor-link part 110 to the master robot 1.

The component by which the manipulation device is connected to the master robot 1, i.e. the component that connects the scissor-link part 110 with the master robot 1, will be referred to as the joint part 140. The joint part 140 may be coupled to the master robot 1 in such a way that the joint part 140 is rotatable about a first rotational axis 112 (in FIG. 6, the z-axis). Thus, the manipulation device according to the present embodiment may be rotated about the first rotational axis 112.

However, the first rotational axis 112 according to the present embodiment does not necessarily have to be positioned at the point where the joint part 140 is coupled to the master robot 1. The position of the first rotational axis 112 may also be at the point where the scissor-link part 110 is coupled to the joint part 140, or at a certain point within the scissor-link part 110, or at the point where the handle part 150 is coupled to the scissor-link part 110. Of course, it is possible to have the manipulation device rotate about the first rotational axis 112 with the first rotational axis 112 positioned in another location other than those described above.

The handle part 150, which is the portion held by the operator, may be connected with the joint part 140 by the scissor-link part 110. The scissor-link part 110 may be coupled to the joint part 140 in such a way that the scissor-link part 110 is rotatable about a second rotational axis 114 (in FIG. 6, the y-axis). Thus, the manipulation device according to the present embodiment may be rotated about the second rotational axis 114.

Similar to the case of the first rotational axis 112, the second rotational axis 114 can also be positioned in a location other than that illustrated in FIG. 6.

While FIG. 6 illustrates an example in which the first rotational axis 112 is orthogonal to the second rotational axis 114, the manipulation device does not necessarily have to be rotatable about two orthogonal axes to enable the handle part 150 to move to a certain point in space, and the second rotational axis 114 can be formed intersecting the first rotational axis 112 by a particular angle.

As can be inferred from its name, the scissor-link part 110 may have a basic unit structure that includes two link members coupled together as a structure resembling a pair of scissors. The scissor-link part 110 according to this embodiment may include several of these unit structures connected sequentially in one direction.

This direction in which the unit structures are connected will be referred to as the lengthwise direction. According to the operation of the links, the scissor-link part 110, which is connected sequentially along the lengthwise direction, is able to extend or retract along the lengthwise direction, as shown in FIG. 6. Thus, the scissor-link part 110 is capable of extending and retracting along the lengthwise direction, the scissor-link part 110 is coupled to the joint part 140 such that the scissor-link part 110 is rotatable about the second rotational axis 114, and the joint part 140 is coupled to the master robot 1 such that the joint part 140 is rotatable about the first rotational axis 112. Therefore, the handle part 150 of the manipulation device according to the present embodiment can be moved to any point in space as desired by the user.

In particular, since the distance between the handle part 150 and the master robot 1 can be adjusted by extending and retracting the scissor-link part 110, there is no need to provide a separate space for moving the handle part 150 further from or closer to the master robot 1, and the handle part 150 can be moved very smoothly.

The unit structure of the scissor-link part 110 may be seen as a composite of a first link member 120 and a second link members 122 pivot-coupled with a first pivot pin 116 to form a scissor-like structure. The structure of the scissor-link part 110 according to the present embodiment may include several of these composites coupled sequentially along the lengthwise direction, where adjacent composites may be pivot-coupled with second pivot pins 118.

FIG. 6 illustrates an example of a scissor-link part 110, which includes a total of six unit composites sequentially connected along the lengthwise direction. According to the operation of the link part, the manipulation device can be extended, as in illustration (a) of FIG. 7, or retracted, as in illustration (b) of FIG. 7. The extension and retraction may be performed much more smoothly, compared to the case of a conventional multi-joint link assembly.

There may be processing tolerances in the link members, as well as bearing tolerances in the pivot pins connecting the link members. In the scissor-link part 110 according to this embodiment, an increase in the number of link members, i.e. the number first link members 120 and second link members 122, can lead to an accumulation of such processing tolerances and bearing tolerances.

In this case, the movement on a handle of the manipulation device may not be accurately transferred to the master robot 1, and there is a risk that a fraction of the movement might be absorbed by the accumulated tolerances described above. For example, when the operator moves the handle by a particular distance, the accumulated tolerances in the link part may result in the master robot 1 identifying a smaller amount of movement compared to the actual amount of movement of the handle.

To avoid this, the scissor-link part 110 according to this embodiment may include a pair of second link members 122 connected like scissors to both sides of one first link member 120, instead of having one first link member 120 and one second link member 122, and may use a gap-modifying part 24 to bind the pair of second link members 122 together.

The gap-modifying parts 24 are components for removing gaps around the pivot pins that may occur when the first link members 120 and second link members 122 are connected. FIG. 6 illustrates an example in which the pairs of second link members 122 are fastened with bolts, so that there are no gaps around the pivot pins.

In other words, a gap-modifying part 24 according to this embodiment may be a component for binding a pair of second link members 122 that include a first link member 120 positioned in-between, i.e. for applying pre-tension to the pair of second link members 122. A fastening means, such as a bolt, a screw, a rivet, etc., can be used for the gap-modifying part 24.

FIG. 6 illustrates an example in which the pairs of second link members 122 are fastened with bolts to be applied with pre-tension. During the process of coupling the bolts, threads may be processed into the bolt holes perforated beforehand in the second link members, to prevent the bolts from becoming loosened or separated when the scissor-link part is operated. In this way, gaps can be removed from the positions where the first link members 120 and second link members 122 are coupled, i.e. the positions around the first pivot pins 116 or second pivot pins 118.

If a pair of second link members 122 are fastened with the link members pulled towards each other, a large amount of friction may build up between the two link members around the first pivot pin 116 and/or the second pivot pins 118, so that the two link members may not freely rotate about the pivot pin. In this case, a flange bearing can be used at the first pivot pin 116 and/or second pivot pin 118, to allow the two link members to rotate freely.

However, it does not necessarily have to be a flange bearing applied to the first pivot pin 116 and/or second pivot pin 118, and it is obvious that other types of bearing may be used that are capable of preventing an increase in friction and of enabling the two link members to rotate freely, even when the pair of second link members 122 are pressed onto the first link member 120. For example, a spacer can be applied between multiple bearings connected along the same axis, to prevent the occurrence of friction.

For the manipulation device according to this embodiment, it may be more advantageous if moving the handle part 150 to a desired position requires an even amount of force regardless of the position of the handle part 150. For example, if a movement of the handle part 150 along the direction of gravity were to require a greater or smaller force than that require to move the handle part 150 horizontally, there is a risk that, during a robot surgery procedure, the handle part 150 may move more along the direction that requires a smaller force against the intentions of the operator. Moreover, if the handle part 150 were to droop downwards due to gravity, even when the operator does not manipulate the handle part 150, the slave robot arm might operate accordingly, possibly resulting in a medical accident.

Thus, the manipulation device of a master robot 1 according to the present embodiment may include driving motors for rotating different components. The driving motors may serve to apply driving forces beforehand to the respective components of the manipulation device, in order that the handle part 150 may require an even amount of force regardless of the direction it is moved in.

In the case of the scissor-link part 110 according to the present embodiment, the first link members 120 and the second link members 122 can be rotated about the first pivot pins 116 by a first driving motor 126 and rotated about the second pivot pins 118 by a second driving motor 128. It is possible to couple the first driving motor 126 and the second driving motor 128 directly onto a first pivot pin 116 and a second pivot pin 118, but in order to offset the mass of manipulation device, the driving motors can be mounted on the master robot 1 and connected with the pivot pins by pulleys (not shown), etc. The position of the driving motors and the connection with the pivot pins may be implemented in various ways in consideration of the mass of the manipulation device, the complexity of the driving mechanism, the design of the master robot 1, etc.

In addition to the first and second driving motors 26, 28, it is also possible to couple a driving motor to the first rotational axis 112 described above and thus provide a supplementary driving force, so that rotating the manipulation device according to this embodiment about the first rotational axis 112 may not require an unnecessarily large amount of force or an uneven amount of force, compared to movements and rotations in other directions.

To each of the driving motors coupled to the manipulation device according to the present embodiment, a position sensor can be connected that generates signals according to how much the driving motor is operated. The position sensor can output the position of the handle part 150 in accordance with the movement of the handle part 150. Thus, the slave robot arm, etc., connected to the master robot 1 can be moved in accordance with the manipulation of the handle part 150 mounted on the master robot 1, making it possible to conduct robot surgery by remotely manipulating the robot arm.

The component by which the manipulation device is connected to the master robot 1, i.e. the component that connects the scissor-link part 110 with the master robot 1, is the joint part 140. The joint part 140 may be coupled to the master robot 1 in such a way that the joint part 140 is rotatable about a first rotational axis 112 (in FIG. 6, the z-axis). Thus, the manipulation device according to the present embodiment may be rotated about the first rotational axis 112.

The scissor-link part 110 according to the present embodiment may be coupled to the joint part 140. More specifically, the first link member 120 coupled to the end portion of the scissor-link part 110 may be coupled to the joint part 140 by way of the second rotational axis 114, as illustrated in FIG. 6, so that the scissor-link part 110 can be rotated about the second rotational axis 114.

In this case, the first link member 120 that is coupled to the joint part 140 can be extended by a certain amount to pass beyond the second rotational axis 114, and a weight 130 can be coupled to the extended end, so that the weight 130 may act as a weight balance for the scissor-link part 110. With the scissor-link part 110 and the handle part 150 coupled to one side of the second rotational axis 114, a weight 130 having a corresponding mass can be coupled to the other side of the second rotational axis 114, so that the arrangement of the scissor-link part 110 and the handle part 150 can be prevented from drooping downwards due to its own mass.

The first link member 120 that extends beyond the second rotational axis 114 does not necessarily have to be one member, and it is obvious that a multiple number of members can be coupled together to serve as one first link member 120.

If the weight 130 is used in this manner as a weight balance, the driving motors described above can drive the manipulation device with smaller amounts of driving force. For example, if the weight 130 is not used, a driving motor may have to deal with not only the force for rotating the link members, but also the force for resisting the mass of the scissor-link part 110 and handle part 150. On the other hand, if the weight 130 is used, the driving motor may have to deal with only the force for rotating the link members, so that the driving mechanism for the manipulation device can be made with a slimmer form.

Also, if the first driving motor 126 is configured to apply a driving force that prevents the manipulation device from drooping downwards because of its own mass, the load on the first driving motor 126 can be reduced by using the weight 130 described above to offset the mass of the manipulation device.

If the manipulation device is moved and rotated using the first driving motor 126 and second driving motor 128, as described above, the mass of each of the driving motors can also be utilized in the weight balance.

That is, the first driving motor 126 and second driving motor 128 can be coupled with the weight 130, so that the driving motors may also serve as a weight balance. In this case, the mass of the weight 130 can be offset by the combined mass of the first driving motor 126 and second driving motor 128, so that the manipulation device according to this embodiment may be implemented with a slimmer form. The driving motors and the weight 130 can be coupled in various ways in consideration of the mass of the manipulation device, the complexity of the driving mechanism, the design of the master robot 1, etc.

While the above descriptions have been provided for an example in which the manipulation device of the master robot is used for a surgical robot, it is obvious that the arrangement of a master robot and a connected slave robot can be used for various other purposes.

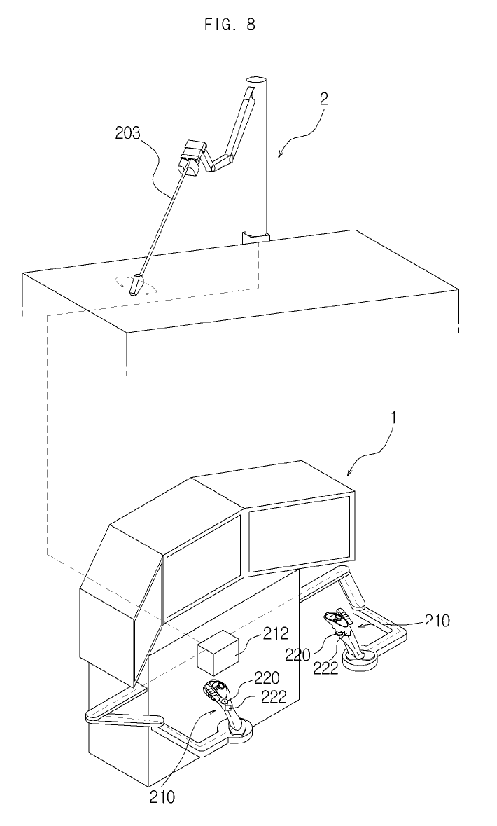

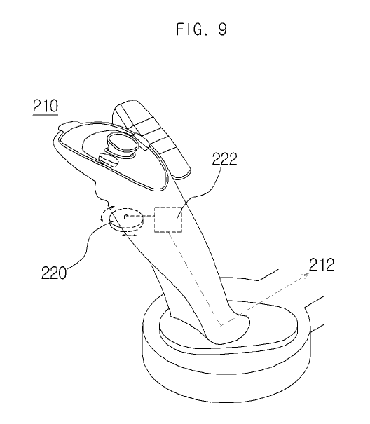

FIG. 8 is a schematic drawing illustrating a master interface for a surgical robot according to an embodiment of the present invention, and FIG. 9 is a perspective view of a handle according to an embodiment of the present invention. Illustrated in FIG. 8 and FIG. 9 are a master robot 1, a slave robot 2, an instrument 203, handles 210, a processor 212, manipulation wheels 220, and a force-feedback part 222.

This embodiment relates to a master interface in which a manipulation wheel 220 is mounted on the handle 210 of a surgical master robot 1, where turning the manipulation wheel 220 causes the instrument 203 mounted on the slave robot 2 to rotate. In the related art, an operator performing a suturing procedure, etc., may have to turn the wrist on the hand holding the handle 210, in order to rotate the instrument 203. In the master interface according to this embodiment, however, the repeated rotating actions on the instrument 203 can readily be implemented by simply rotating the manipulation wheel 220, instead of arduously turning the wrist.

The master interface according to this embodiment may be installed on a surgical master robot 1, in a surgical robot composed mainly of a master robot 1, a slave robot 2 connected to the master robot 1, and a surgical instrument 203 mounted on the slave robot 2. A person conducting robot surgery may manipulate the master interface, whereby the instrument 203 mounted on the slave robot 2 may move and rotate, to thus perform the robot surgery.

As illustrated in FIG. 8, the master interface is a concept that encompasses not only the manipulation handles 210 mounted on the surgical master robot 1, but also the processors for signal processing, consoles, monitors, and other operating switches connected to the handles. The master interface serves as an interface which identifies user manipulation on the master robot 1 to operate the slave robot 2.

The master interface according to this embodiment can be composed mainly of a handle 210 coupled to the master robot 1, a manipulation wheel 220 coupled to the handle 210, and a processor 212 for generating signals according to user manipulation on the manipulation wheel 220.

The manipulation wheel 220 may be coupled to the handle 210 to be rotatable about a particular rotational axis. Here, the rotational axis is a concept encompassing not only an actual rotational axis that passes through the center of rotation of the manipulation wheel 220, but also a virtual rotational axis that does not physically exist, such as in cases where the manipulation wheel 220 is made to rotate by means of another rotating device. In other words, the manipulation wheel 220 according to the present embodiment may be formed to rotate about an actual or a virtual rotational axis.

Coupling the manipulation wheel 220 to the handle 210 in this manner enables manipulations that involve repeatedly rotating the manipulation wheel 220, and the instrument 203 mounted on the slave robot 2 can be driven in correspondence with the manipulation on the manipulation wheel 220. The rotating of the manipulation wheel 220 can be connected as necessary with a driving action on a certain instrument 203, and in order that the user may intuitively guess the action, the repeated rotating of the manipulation wheel 220 can be connected with a repeated rotation of the instrument 203.

The master robot 1 may be equipped with a processor 212, which may identify user manipulation on the master interface to generate certain signals, and which may transfer these signals to the slave robot 2 to drive the slave robot 2 and/or the instrument 203. The processor 212 according to this embodiment may generate a signal that drives the instrument 203 in accordance with the rotation of the manipulation wheel 220. Here, Referring to the processor 212 is merely for differentiating the courses of signal processing, and it is obvious that the processor 212 does not necessarily have to be physically separated and can be integrated in a single semiconductor chip.

To provide a driving action that is intuitive to the user by connecting the repeated rotating manipulation on the manipulation wheel 220 with the repeated rotating action of the instrument 203, the processor 212 according to the present embodiment can be made to generate a signal for rotating the tip of the instrument 203 in correspondence to how much the manipulation wheel 220 is rotated. For example, the arrangement can be configured such that rotating the manipulation wheel 220 once causes the tip portion of the instrument 203 to rotate once for performing suturing. In this case, if the suturing requires rotating the instrument 203 an n number of times, the suturing procedure can be performed by rotating the manipulation wheel 220 an n number of times.

Of course, if the suturing procedure cannot be completed only with rotating the instrument 203 an n number of times, other manipulations can be included in-between each rotation of the manipulation wheel 220, so that the manipulation part mounted on the tip of the instrument 203 may hold on to the suture.

In other words, the manipulation wheel 220 can be turned, to rotate the instrument 203 and pass a needle through the suturing site, after which the instrument 203 can be manipulated to hold the needle again, and the action of rotating the instrument 203 can be repeated.

It is possible to couple the manipulation wheel 220 to the handle 210 in a manner that enables a clicking action, i.e. a click function can be added to the manipulation wheel 220. Then, rotating the manipulation wheel 220 may be connected with an action for rotating the instrument 203, while clicking the manipulation wheel 220 may be connected with an action for returning the instrument 203 to its preset initial position, i.e. initializing the instrument 203, thereby providing a convenient and intuitive approach to performing a suturing procedure.

Moreover, when rotating the instrument 203 by turning the manipulation wheel 220, the orientation of the wrist may not be aligned with the orientation of the tip of the instrument 203, in which case the click function of the manipulation wheel 220 described above can be matched to an action for aligning and initializing the orientation of the instrument 203. Furthermore, while a needle is held in the tip of the instrument 203, the click function of the manipulation wheel 220 may be deactivated, in order to prevent the instrument 203 from inadvertently returning to its initial position. In this way, the safety of the robot surgery process can be ensured, even when a click function is added to the manipulation wheel 220.

The rotation of the manipulation wheel 220 does not necessarily have to match the rotation of the instrument 203 exactly one-to-one, and the rotation ratio between the manipulation wheel 220 and the instrument 203 can be set differently. For example, the instrument 203 can be rotated n times per one rotation of the manipulation wheel 220 for speedy operation, or the instrument 203 can be rotated once per n rotations of the manipulation wheel 220 for greater precision. The rotation ratio can be set as a predefined value and can be modified by the user as necessary.

With the processor 212 configured in this manner such that repeatedly rotating the manipulation wheel 220 implements a repeatedly rotating action of the instrument 203, the surgical robot according to the present embodiment can be made to rotate the instrument 203 as necessary by an unlimited number of repetitions, using a simple manipulation of rotating the manipulation wheel 220, instead of having to turn the wrist on the hand gripping the handle 210 according to the related art.

Thus, the manipulation wheel 220 according to this embodiment replaces the repetitive rotations on the wrist with rotating manipulations on the manipulation wheel 220, allowing the user to manipulate the surgical robot with greater ease. Of course, the manipulation of the master interface according to the present embodiment for rotating the instrument 203 is not necessarily limited to manipulating the manipulation wheel 220. A user may also rotate the instrument 203 by turning the wrist to manipulate the handle 210, similar to the related art. A user who is skilled in manipulating a conventional surgical robot may, according to the preference of the user, choose whether to rotate the handle 210 or use the manipulation wheel 220 according to the present embodiment in performing robot surgery.

As described above, the instrument 203 can be repeatedly rotated an unlimited number of times by rotating the manipulation wheel 220 according to the present embodiment. The instrument 203 mounted on the slave robot 2 can also be configured to rotate within a predetermined range, according to the mechanical composition of the arrangement.

If the instrument 203 is mounted to the slave robot 2 in this manner to be rotatable only within a preset range of rotation, the instrument 203 may not rotate beyond the rotation limit even regardless of the rotation of the manipulation wheel 220. In such cases the rotation of the manipulation wheel 220 corresponds to rotating the instrument 203 beyond the rotation limit, it is conceivable to also limit the rotation of the manipulation wheel 220 to a particular range, similar to the instrument 203, so that the user may be informed of the rotation limit set on the instrument 203.

Thus, the user manipulating the manipulation wheel 220 may perceive that the instrument 203 has reached its rotation limit and make another manipulation, such as of rotating the instrument 203 back to its original position, and thereby operate the instrument 203 as desired without excessively rotating the manipulation wheel 220.

For this purpose, the manipulation wheel 220 according to this embodiment can include a force-feedback part can be coupled thereto, which may apply a reaction force in an opposite direction to limit the rotation of the manipulation wheel 220.

A force feedback refers to a function of returning the result of a manipulation in the form of a force applied to the mechanism used for inputting the manipulation, or to a system utilizing this function. This may be used in a game console, for example, where the manipulation device can simulate a realistic impact or a vibration during a game by means of a built-in motor in the manipulation device that generates a reaction force or a vibration and delivers a life-like sensation to the user.

The force-feedback part 222 according to this embodiment may serve to limit the rotation of the manipulation wheel 220 when the instrument 203 reaches its rotation limit. When the instrument 203 is to be rotated beyond the rotation limit, that is, when the manipulation wheel 220 is rotated to an extent that causes the instrument 203 to exceed the rotation range, the force-feedback part 222 may be activated to apply a reaction force against the rotation of the manipulation wheel 220.

The force-feedback part 222 may include a motor, etc., coupled to the manipulation wheel 220, and may be activated by a signal received from the processor 212 when the instrument 203 is to be rotated beyond the rotation limit. When the force-feedback part 222 is activated, the motor, etc., may apply a reaction force to the manipulation wheel 220. This can result in the user being unable to rotate the manipulation wheel 220 or requiring a larger force than usual in rotating the manipulation wheel 220. The user may then perceive the rotation limit of the instrument 203 and may either stop rotating the manipulation wheel 220 or make a different manipulation.

For example, whereas a conventional surgical robot, in which the instrument 203 was rotatable only within a specified angle, may require the user to repeat the operations of turning and releasing the wrist holding the handle 210 when performing a suturing procedure, the manipulation wheel 220 according to this embodiment enables the user to rotate the instrument 203 and perform a suturing procedure using a simple manipulation involving rotating the manipulation wheel 220. Also, if the force-feedback part 222 is coupled to the manipulation wheel 220, rotating the manipulation wheel 220 such that the instrument 203 would be rotated beyond a specified angle may cause a motor, etc., to apply a reaction force and thus prevent the manipulation wheel 220 from rotating further, so that the robot surgery may be performed smoothly without excessively burdening the master interface.

As illustrated in FIG. 9, the manipulation wheel 220 according to this embodiment can be mounted in a position that allows the user to easily rotate the manipulation wheel 220 with a finger. That is, the position of the manipulation wheel 220 can be adjusted such that the user may turn the manipulation wheel 220 using a finger, such as a thumb, index finger, middle finger, etc., according to the circumstances of the manipulation. For example, if the arrangement is configured such that the user may grip the handle 210 with one hand for manipulation, then the manipulation wheel 220 can be mounted in a position where the user's finger, i.e. a thumb, index finger, middle finger, etc., would be located.

In the handle 210 coupled to the master robot 1, a finger rest, hanger, manipulation button, clutch button, etc., can be positioned where each of the thumb and the index finger would be located when the user grips the handle 210. In this case, the manipulation wheel 220 according to the present embodiment can be installed in the column portion of the handle 210 where the middle finger would be located. Then, the user, while holding the handle 210 with one hand, may perform a rotating action on the instrument 203 described above by rotating the manipulation wheel 220 with the middle finger, in addition to manipulating the various buttons with the thumb and index finger.

With the manipulation wheel 220 thus installed in the portion that would be touched by the middle finger when the handle 210 is gripped, the instrument 203 can readily be rotated by a simple manipulation of rotating the manipulation wheel 220, instead of turning the wrist according to the related art.

While the present invention has been described with reference to particular embodiments, it will be appreciated by those skilled in the art that various changes and modifications can be made without departing from the spirit and scope of the present invention, as defined by the claims appended below.

1. A master interface for a surgical robot, the master interface mounted on a master robot to manipulate a slave robot connected with the master robot, and activated with mounting of a first surgical equipment and a second surgical equipment, the master interface comprising:
a main handle coupled to the master robot, and manipulated to move certain way by user;
a sub-handle coupled to the main handle, and manipulated to move certain way by user while the main handle is manipulated;
a first processor configured to generate a first signal in correspondence with movement of the main handle; and
a second processor configured to generate a second signal in correspondence with movement of the sub-handle,
wherein the first signal and the second signal are transmitted to the slave robot independently, the first signal is used to activate the first surgical equipment in correspondence with movement of the main handle, and while the first surgical equipment is activated the second signal is used to activate the second surgical equipment in correspondence with movement of the sub-handle.

2. The master interface according to claim 1, wherein a surgical robot arm and a laparoscope are mounted on the slave robot,
the first signal is used for manipulating the robot arm, and
the second signal is used for manipulating the laparoscope.

3. (canceled)

4. (canceled)

5. The master interface according to claim 1, wherein the master robot comprises a monitor configured to display information required for manipulating the slave robot, and
the second signal is used for manipulating a cursor on the monitor.

6. The master interface according to claim 5, wherein a clutch button is coupled to the master robot, and
the second signal is used for manipulating the cursor on the monitor in correspondence with whether or not the clutch button is activated.

7. The master interface according to claim 1, wherein the first processor is configured to compare data obtained from user manipulation on the main handle with preset reference data, and generate the first signal according to whether or not the obtained data match the preset reference data.

8. The master interface according to claim 1, wherein the second processor is configured to compare data obtained from user manipulation on the sub-handle with preset reference data, and generate the second signal according to whether or not the obtained data match the preset reference data.

9. (canceled)

10. (canceled)

11. (canceled)

12. (canceled)

13. (canceled)

14. (canceled)

15. (canceled)

16. (canceled)

17. A manipulation device for a master robot, the manipulation device connected to the master robot to manipulate a slave robot connected to the master robot, the manipulation device comprising:
a joint part coupled to the master robot by way of a first rotational axis;
a scissor-link part coupled to the joint part by way of a second rotational axis, comprises a composite of a first link member and a second link member connected to each other in a scissor-like manner by way of a first pivot pin, the composites connected sequentially along a lengthwise direction by way of a second pivot pin, and configured to extend or retract along the lengthwise direction according to a driving thereof; and
a handle part coupled to the scissor-link part, and moved to a certain location in space by user manipulation.

18. The manipulation device according to claim 17, wherein a surgical robot arm is coupled to the slave robot, and
the robot arm is configured to move and rotate in correspondence with a movement and rotation of the manipulation device.

19. (canceled)

20. (canceled)

21. The manipulation device according to claim 17, wherein the handle part is coupled to the scissor-link part by way of a third rotational axis.

22. The manipulation device according to claim 17, wherein the first rotational axis intersects the second rotational axis.

23. (canceled)

24. The manipulation device according to claim 17, wherein a pair of the second link members are connected respectively to both sides of the first link member, and
the manipulation device further comprises a gap-modifying part binding the pair of second link members.

25. The manipulation device according to claim 24, wherein the gap-modifying part comprises at least one selected from a group consisting of bolts, screws, and rivets, the gap-modifying part configured to apply pre-tension to the pair of second link members.

26. The manipulation device according to claim 24, wherein the first pivot pin and the second pivot pin connect the first link member and the second link members by way of interposed flange bearings.

27. The manipulation device according to claim 17, further comprising:
a first driving motor configured to rotate the first link member and the second link member about the first pivot pin; and
a second driving motor configured to rotate the first link member and the second link member about the second pivot pin.

28. The manipulation device according to claim 27, wherein the first driving motor and the first pivot pin are connected by a pulley, and the second driving motor and the second pivot pin are connected by a pulley

29. The manipulation device according to claim 27, wherein the first link member is coupled to the joint part by way of the second rotational axis,
a portion of the first link member extends beyond the second rotational axis, and
a weight corresponding with a mass of the scissor-link part is coupled to the extended portion of the first link member.

30. The manipulation device according to claim 29, wherein the first driving motor and the second driving motor are included in the weight.

31. A master interface for a surgical robot, the master interface installed on a master robot connected with a slave robot to manipulate a surgical instrument mounted on the slave robot, the master interface comprising:
a handle coupled to the master robot;
a manipulation wheel coupled to the handle, the manipulation wheel configured to rotate about a particular rotational axis; and
a processor mounted on the master robot, the processor configured to generate a signal for driving the instrument in correspondence with a rotation of the manipulation wheel.

32. The master interface according to claim 31, wherein the processor generates a signal for rotating a tip of the instrument in correspondence with a degree of rotation of the manipulation wheel.

33. The master interface according to claim 32, wherein the instrument is mounted on the slave robot such that the tip of the instrument is able to rotate within a preset range,
a force-feedback part is coupled to the manipulation wheel, the force-feedback part configured to apply a reaction force to limit a rotation of the manipulation wheel, and
the processor is configured to generate a signal for activating the force-feedback part when the manipulation wheel is rotated such that the instrument exceeds the preset range of rotation.

34. The master interface according to claim 31, wherein the handle is formed in a shape which enables a user to grip the handle with one hand, and
the manipulation wheel is coupled in a position which enables a user to manipulate the manipulation wheel with a middle finger when the user grips the handle.

35. The master interface according to claim 31, wherein the manipulation wheel is coupled to the handle in a manner which enables a clicking action.

36. The master interface according to claim 35, wherein the processor is configured to generate a signal for returning the instrument to a preset position in correspondence with a clicking action of the manipulation wheel.
